(19) United States
(12) Patent Application Publication
(10) Pub. No.: US 2003/0074459 A1
(43) Pub. Date: Apr. 17, 2003

(54) Proprietary protocol for a system controller for controlling device controllers on a network having an open communication protocol

(76) Inventors: Michael Soemo, Lombard, IL (US); Pierre DeSmul, Wilmette, IL (US); Mark Gagner, West Chicago, IL (US); Geoffrey D. Nass, Schaumburg, IL (US)

Correspondence Address: Siemens Corporation, Intellectual Property Department, 186 Wood Avenue South, Iselin, NJ, 08830, US

(21) Appl. No.: 09/966,738

(22) Filed: Sep. 28, 2001

(51) Int. Cl. G06F 15/16

(52) U.S. Cl. 709/230; 700/276

(57) ABSTRACT

A proprietary communication protocol is used in a system controller that includes an application controller and a plurality of applications for controlling a plurality of device controllers on a control network by using data relating to system points that correspond to data variables in the network. The protocol communicates a plurality of predefined messages between the application controller and the applications for instructing the application controller to perform a function relating to a select system point, and for reporting to the applications in response to the instructions. The protocol includes a message identification field for identifying a select message from the plurality of messages; and a protocol identification field for identifying the select message as being transmitted via the proprietary communication protocol.

### BACKGROUND

The present invention generally relates to a communication protocol used in system controllers for network control systems, and more particularly to a protocol for a system controller for controlling a control system having a network with an open communication protocol.

It is known in the control systems industry, especially the building control systems, to employ a control network to allow various system components to communicate with each other. Until recently, communication between the components in the network was handled through proprietary protocols developed by the control network developers/manufacturers. Increasingly, however, the control networks are now being implemented with open communication standards such as LonTalk® and BACnet. These communication protocols permit system components that are produced by different manufactures to communicate with each other, thus providing the network designers the flexibility to choose system components from various sources.

Known control systems typically include one or more system controllers that are connected via a control network to device controllers that operatively control network devices. The system controllers typically transmit commands to the device controllers for operating the network devices, and also receive data from the device controllers regarding status and other information about the network devices that may be of interest to the system controller for making decisions.

A problem associated with the known control system arrangements is that the communication between the system controller and the device controllers must be conducted via the open protocol of the system network. These protocols do not always have the capacity to provide the support necessary for implementing complex and increased functionalities required by some control systems, such as a Heating/Ventilation/Air Conditioning (HVAC) system, for example. The known control system arrangements also limit designers' creativity in solving problems or expanding the capabilities of the system controller, because the designers are confined to the protocol of and the type of data provided by the network in place. Addition of new control applications to the control system is also complicated for the same reasons.

### SUMMARY OF THE INVENTION

The present invention is directed a communication protocol which is employed in a system controller for controlling device controllers in a control system that is built around a network utilizing a network specific communication data format and protocol. The present proprietary protocol is adapted to be embedded in the network protocol and carry proprietary data between an application controller and various applications of the system controller.

### BRIEF DESCRIPTION OF THE DRAWINGS

FIG. 1 is a logical block diagram of a system controller that uses the present communication protocol;

FIG. 2 is block diagram of the system controller of FIG. 1 shown incorporated into a control network;

FIG. 3 is a logical block diagram illustrating the types of communication protocols that may be employed in the control network;

FIG. 4 is an illustration of the data fields associated with a single system point (SP) data format;

FIG. 5 is a simplified illustration of various fields that are selectively provided in the system point protocol messages of the present invention;

FIG. 6 is an illustration of a notification field in some of the present system point protocol messages;

FIG. 7 is a system point protocol message format for a MSG_ID_SP_DISCOVER_PUID message;

FIG. 8 is a system point protocol message format for a MSG_ID_SP_DISCOVER_NAME message;

FIG. 9 is a system point protocol message format for a MSG_ID_SP_SUBSCRIBE_EL message;

FIG. 10 is a system point protocol message format for a MSG_ID_SP_UNSUBSCRIBE_EL message;

FIG. 11 is a system point protocol message format for a MSG_ID_SP_UNSUBSCRIBE_ALL_EL message;

FIG. 12 is a system point protocol message format for a MSG_ID_SP_OVERRIDE_WRITE_SP message;

FIG. 13 is a system point protocol message format for a MSG_ID_SP_RELEASE message;

FIG. 14 is a system point protocol message format for a MSG_ID_SP_VAL_QUERY message;

FIG. 15 is a system point protocol message format for a MSG_ID_SP_QUAL_QUERY message;

FIG. 16 is a system point protocol message format for a MSG_ID_SP_NODE_QUERY message;

FIG. 17 is a system point protocol message format for a MSG_ID_SP_CANCEL_TRANSACTION message;

FIG. 18 is a system point protocol message format for a MSG_ID_SP_SUBSCRIBE_EVENT message;

FIG. 19 is a system point protocol message format for a MSG_ID_SP_UNSUBSCRIBE_EVENT message;

FIG. 20 is a system point protocol message format for a MSG_ID_SP_RESYNC message;

FIG. 21 is a system point protocol message format for a MSG_ID_SP_EVENT_RPT_message;

FIG. 22 is a system point protocol message format for a MSG_ID_SP_DISCOVERED message;

FIG. 23 is a system point protocol message format for a MSG_ID_SP_VAL_RPT message;

FIG. 24 is an alternative system point protocol message format for the MSG_ID_SP_VAL_RPT message of FIG. 23;

FIG. 25 is a system point protocol message format for a MSG_ID_SP_QUAL_RPT message;

FIG. 26 is an alternate system point protocol message format for the MSG_ID_SP_QUAL_RPT message of FIG. 25;

FIG. 27 is a system point protocol message format for a MSG_ID_SP_EVENT_RPT message; and,

FIG. 28 is a system point protocol message format for a MSG_ID_APPLICATION_ERROR message.

### DETAILED DESCRIPTION

Broadly stated, the present invention is directed to a proprietary communication protocol used in a system controller that includes an application controller and a plurality of applications for controlling a plurality of device controllers on a control network by using data relating to system points that correspond to data variables in the network. The protocol communicates a plurality of predefined messages between the application controller and the applications for instructing the application controller to perform a function relating to a select system point, and for reporting to the applications in response to the instructions. The protocol includes a message identification field for identifying a select message from the plurality of messages, and a protocol identification field for identifying the select message as being transmitted via the proprietary communication protocol.

In accordance with another aspect of the present invention, a proprietary communication protocol is used in a system controller that includes an application controller and a plurality of applications for controlling a plurality of device controllers on a control network by using data relating to system points that correspond to data variables in the network. The protocol communicates a plurality of predefined messages between the application controller and the applications for instructing the application controller to report events that occur in the applications and the device controllers, and for reporting to the applications in response to the instructions. The protocol includes a message identification field for identifying a select message from the plurality of messages, and a protocol identification field for identifying the select message as being transmitted via the proprietary communication protocol.

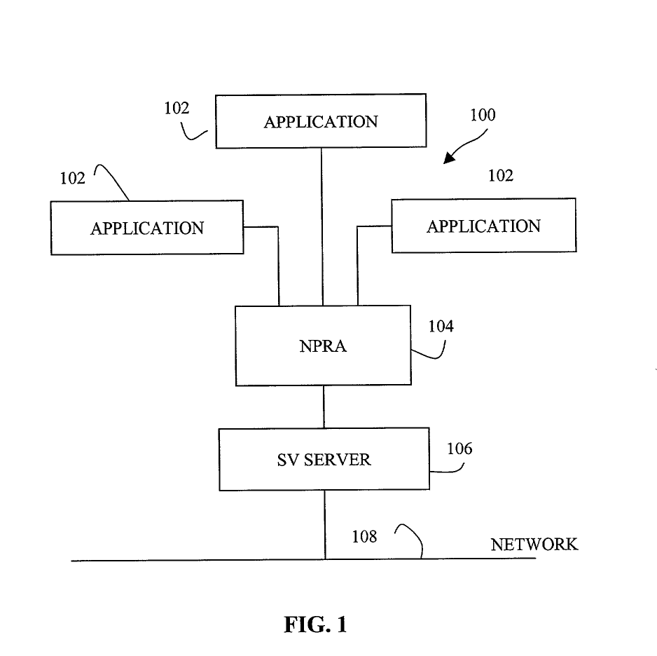

Turning now to FIG. 1, a system controller in which the present communication protocol is used to transmit data is indicated generally at 100 and includes a plurality of applications 102, which are in communication with a network point record application (NPRA) 104. A system variable (SV) server 106 is connected between the NPRA 104 and a control network 108 and serves as an interface between the NPRA 104 and the network data flow. It should be noted that FIG. 1 is a logical data flow view of the system controller 100 and that the SV server 106 and the applications 102 may reside at different locations along the network 108 from that of the NPRA 104. The NPRA 104 and the applications 102 may communicate directly, bypassing the SV server 106, or via the network through the SV server 106.

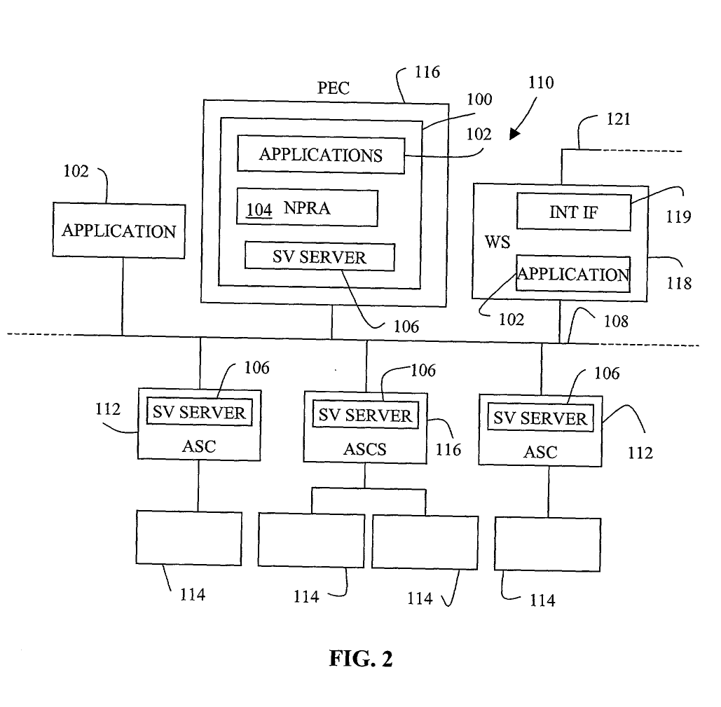

As shown in FIG. 2, a control system 110 includes a plurality of device controllers that are network 108 compliant. They include application specific controllers (ASC) 112 (two shown) for controlling a number of physical devices 114, for example, a variable air volume (VAV) box that controls a fan for blowing hot or cold air into an area. Also included are a number is programmable equipment controllers (PEC) 116 (one shown), which also control physical devices 114 in the control system 110. In addition, the PECs 116 include features for enabling more sophisticated control processes, and generate data necessary for producing system reports. A workstation (WS) 118 allows a user of the control system 110 to input instructions to the device controllers 112, 116 for controlling the physical network devices 114, and gain access to the system data necessary for making decisions regarding the operation of the control system 110.

The WS 118, in the preferred embodiment, includes an internet interface 119 which allows the WS to be interfaced with the internet 121. A connection to the internet can be through an ethernet card or though a modem. Alternatively, an internet interface 119 can be provided in one of the PECs 116, in which case the connection mechanism to the internet 121 would be hard coded into the PEC instead of using an ethernet card. In this manner, the operation of the control system 110 can be controlled remotely through the internet 121.

The applications 102 may be a part of the workstation 118 used to subscribe for changes in the status of the network devices 114, for example. They might also be a part of the PEC 116, such as an alarm detector for detecting and reporting alarm conditions to an operator, or a totalization application for totalizing and calculating power used by the network devices 114, or for calculating the total ON time for a device such as a fan. The NPRA 104 provides a means of data collection, translation, reporting, and updating from data sources on the network 108. The SV servers 106 facilitate transmission of data or system variables (SVs) from the device controllers 112, 116 to the NPRA 104, and data from the NPRA to the device controllers. The term system variables (SV) is defined to be values or data associated with the network devices 114 that are transmitted through the network via the network communication protocol, e.g., voltage from a sensor, a temperature reading, etc.

As shown in FIG. 2, the system controller 100 is provided in the PEC 116 or the workstation 118, but it may also be provided independently in a stand-alone unit. Each system controller 100 includes one NPRA 104, a plurality of applications 102 and one or more SV servers 106 which are incorporated into the device controllers 112, 116. Each ASC and PEC 112, 116 represents a “node” in the network 108, which is a logical location of the SV server 106. While only one system controller 100 is shown in FIG. 2, it should be understood that more than one system controller may be provided in the control system 110, where each system controller would be responsible for operatively communicating with its designated nodes.

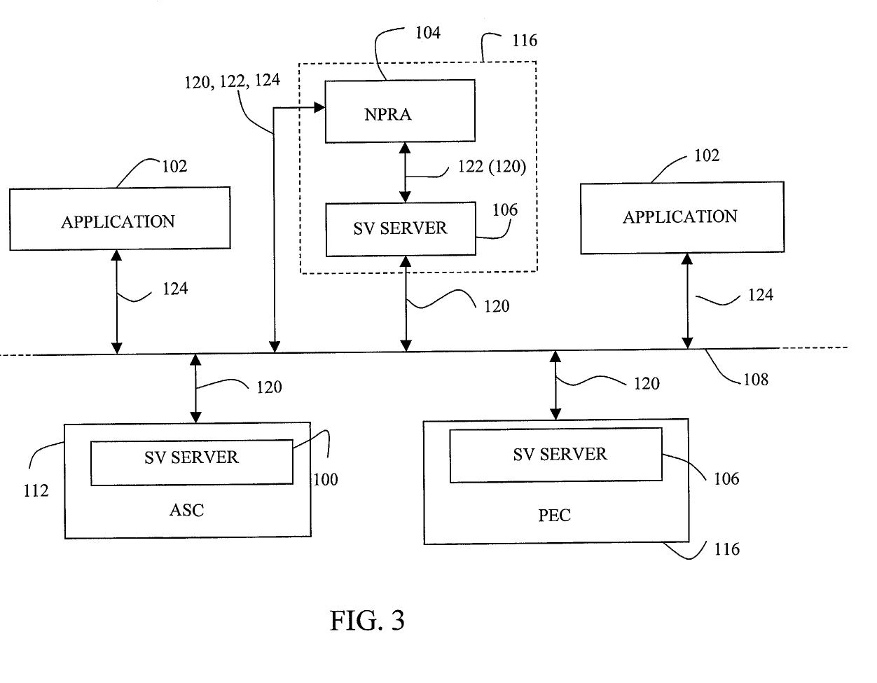

Turning now to FIG. 3, communication between the device controllers 112, 116 is through a protocol 120 that is specific to the network 108 on which the system controller 100 is connected, such as for example, LonTalk® in a LON network. Data or system variables (SVs) that are transmitted between the SV servers 106 and the device controllers 112, 116 are in the format defined by the network protocol 120. Between the SV servers 106 and the NPRA 104, the format of the data being transmitted is the same as at the network level. Accordingly, the mechanism of the protocol 120 of the network 108 may be utilized in transmitting data, either through the local SV server 106 or directly between the NPRA 104 and the SV servers 106 in the other device controllers 112, 116 in the network 108.

A proprietary communication protocol 122 may also be used to transmit data between the NPRA 104 and the SV servers 106, so as to provide a layer of abstraction between the network 108 and the NPRA. In other words, the proprietary protocol 122 used between the SV servers 106 and the NPRA 104 would further isolate the system controller 100 from the network 108, so that the system controller is not bound to one particular control network. The proprietary protocol 122 at this level would also allow the system controller designers to implement additional capabilities in manipulating data or system variables. One example of the proprietary protocol 122 for implementing between the NPRA 104 and the SV servers 106 is described in detail in a commonly assigned patent application entitle PROPRIETARY PROTOCOL FOR COMMUNICATING NETWORK VARIABLES ON A CONTROL NETWORK, filed simultaneously herewith.

In accordance with the present invention, a “system point” (SP) is assigned for each system variable (SV) on the network 108 and other network data not associated with system variables. A system point might represent a room temperature or a room temperature setpoint measured or set by a thermostat (which would be a network device 114 shown in FIG. 2), for example. Each SP has associated dynamic and static information that are organized into various data fields. When the system variables (SV) from the SV server 106 are received, the NPRA 104 converts or maps the SVs into corresponding SPs.

In accordance with the present invention, data relating to the SPs are communicated between the NPRA 104 and the applications 102 via a system point (SP) protocol 124. The SP protocol is preferably embedded into the network protocol 120 of the network 108. In the LONTalk® protocol, for example, the SP protocol would be incorporated into the “explict messages” fields specifically designated for incorporation of proprietary communication messages.

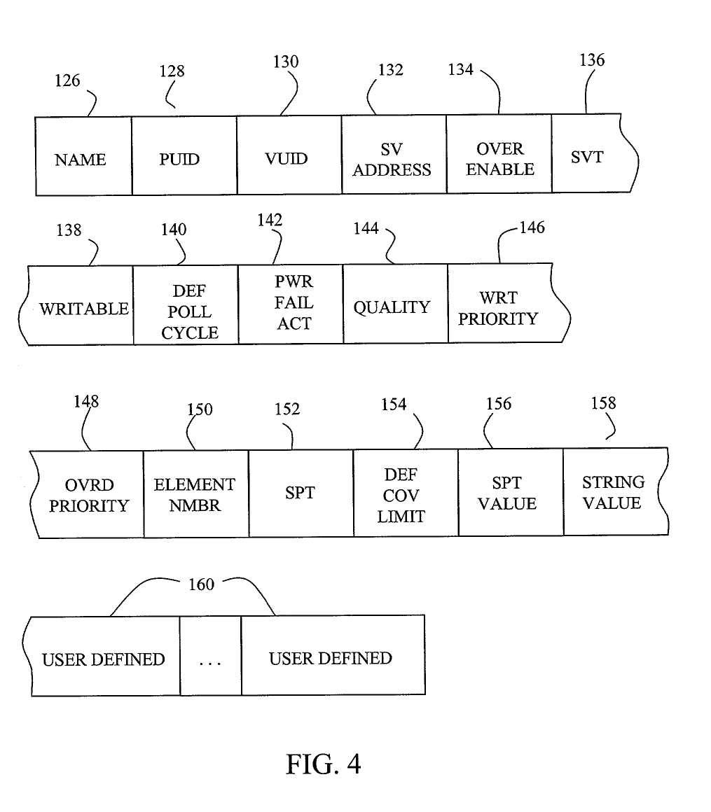

Turning now to FIG. 4, a single SP 126 is shown and includes a plurality of fields which describe the characteristics of the SP. The fields of the SP 126 are described in TABLE 1 below (the number next to the field name corresponds to the reference numerals of FIG. 4).

TABLE 1

| Field Name | Type | S/D | Description |
|---|---|---|---|
| Name 126 | Array of | S | User defined SP name. |
| | 36 U08's | | |
| PUID 128 | U32 | S | Unique ID number for the SP. |
| VUID 130 | U32 | S | Unique ID number for the SV |
| | | | associated with the SP. This field |
| | | | will be undefined if the SP is not |
| | | | associated with a SV. |
| SVAddress 132 | U32 | S | The logical address of the SV |
| | | | associated with the SP |
| Over Enable 134 | U08 | S | Indicates whether the SP |
| | | | can be overridden. |
| SVT 136 | U16 | S | The system variable type |
| | | | associated with the SP. |
| Writable 138 | U08 | S | This field defines if the SV |
| | | | corresponding to the SP |
| | | | can be written to. |
| DefPollCycle 140 | R32 | S | Default polling cycle for the SV |
| | | | associated with the SP. |
| PwrFailAct 142 | U08 | S | This field is valid on writeable |
| | | | points only. |
| | | | Describes the action that the NPRA |
| | | | 104 will take when the NPRA |
| | | | is powered-on. |
| Quality 144 | U16 | D | This field provides the quality of |
| | | | the SP's value to indicate the |
| | | | condition of the SV associated |
| | | | with the SP. |
| WrtPriority 146 | U08 | D | The current write priority |
| | | | value of the SP. |
| Ovrd Priority 148 | U08 | D | The current override priority |
| | | | value of the SP. |
| Element Number | U08 | S | The identification number or index |
| 150 | | | of the SP element. |
| SPT 152 | U16 | S | The type of the system point |
| | | | (engineering units). |
| Def COV Limit | R32 | S | Default change of value limit |
| 154 | | | for the SP element. |
| SP Numeric | Array of | D | The current numeric value of an |
| Value 156 | up to 32 | | SP element in |
| | R32's | | system point type (SPT) units. |
| SP String Value | Array of | D | The current string value of an |
| 158 | 32 U08's | | SP element in SPT unit. |
| User Defined 160 | User | D/S | Additional field for use in |
| | defined | | specific applications. |

The column named “Type” indicates the preferred number of bytes reserved for the corresponding fields of the SP. The first letter indicates whether the value is signed (S), unsigned (U) or a real number (R), and the following two numerals indicate the number of bits in the field. For example, the type “U08” represents an unsigned number having 8 bits (i.e., 0 to 255), and the type “S08” represents a signed number having 8 bits (i.e., −128 to +127). The S/D column indicates whether the field is static or dynamic. The static fields are not modified, while the dynamic fields may be modified. The SPs include one or more SP “elements,” each of which is, in effect, an independent variable with an associated dynamic value. For example, one element of the SP could contain a state, while another element could contain the time until that state occurs.

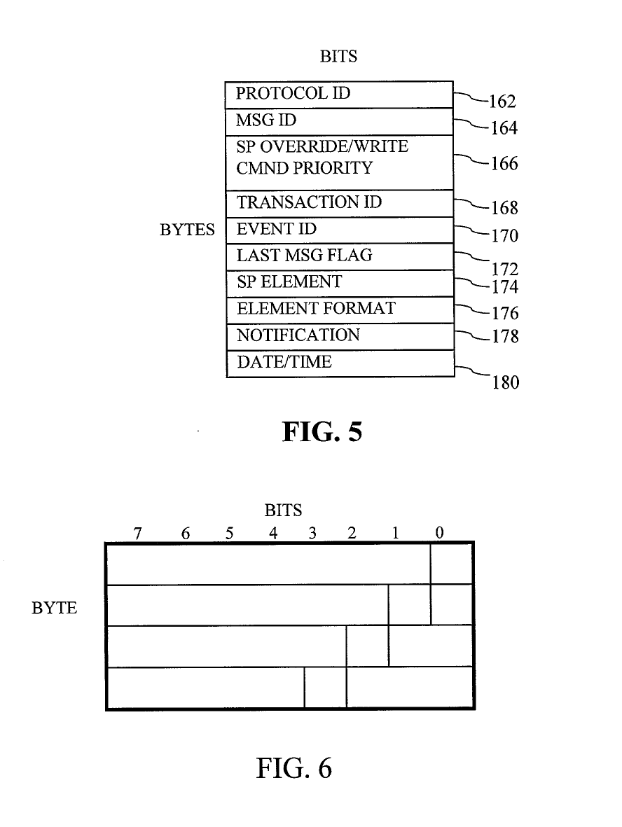

Turning now to FIG. 5, and in accordance with the present invention, the system point (SP) protocol 124 includes a number of common fields, one or more of which are selectively incorporated into different messages. These fields include a protocol identification (ID) field 162 and a message ID field 164. In the preferred embodiment, the protocol ID field 162 is set to PROT_ID_SP, which is an unsigned one byte value, i.e., a U08 value, for all SP protocol messages. The message ID field 164 identifies the type of message that is sent from the clients 102 to the NPRA 104, or from the NPRA to the clients.

An SP override/write command priority field 166 is preferably a one-byte field that holds the values that define the priority levels of the messages that are used to command writing or overriding of the SPs. The term “writing” is defined to mean updating of the SP value, and “override” is defined to mean updating of the existing SP values and also preventing other clients 102 from changing the overridden value. The priority levels prevent low priority clients 102 from overwriting or re-overriding the SP values set by high priority NPRA clients.

A transaction ID field 168, which is a four-byte field in the preferred embodiment, carries values representing the transaction ID of a message sent by the client 102 to the NPRA 104. The same transaction ID is then used in a response message or report from the NPRA 104 to the client 102. In this manner, the messages sent by the client 102 are readily identified with their corresponding responses from the NPRA 104. In the preferred embodiment, the client 102 uses a new and unique transaction ID each time it sends an SP protocol message.

An event ID field 170 holds a value that identifies the type of event that is being subscribed for by the clients 102 from the NPRA 104. The event ID field 170 is also employed when the NPRA 104 reports on events that have occurred in the control system 110, for example, a node failure or a return from a node failure. A last message flag field 172 holds a value that indicates that a response message from the NPRA 104 to the clients 102 is the last in the series of response messages. In the preferred embodiment, the NPRA 104 sets the last message flag field equal to “1” within the last message associated with a particular transaction. In all preceding messages the flag field 172 is set to “0”.

An SP element field 174 carries the values of the two different classes of the SP elements, which are string elements and numeric elements. The string elements are preferably limited to 31 characters in length, and therefore, will have up thirty-one U08 values stored in an array. The numeric element values in the preferred embodiment are expressed as an array of 1 to 31 32-bit floating values (i.e. R32's).

An element format field 176 indicates the format that the SP elements are to be conveyed. In the preferred embodiment, the messages designated as “format 0” convey only the value of the elements (such as for display on a Workstation 118 application 102, while those designated as “format 1” are conveyed with units and formatting information so that the elements can be displayed on a portable (typically hand-held) device application 102. For numeric elements, these messages convey the system point type (SPT), formatting information (such as the element's units and the number of digits right of the decimal point), as well as the value of the numeric elements. For string elements, these messages convey the string length and the variable length character array that contains the contents of the string.

A notification field 178 is provided for setting flags that are used to individually enable, disable or indicate specific notifications relating to particular characteristics of the SPs. This is a single byte field that is bit-mapped as shown in FIG. 6. For example, bit 0 of the field might be used for setting a “change of value” (COV) notification flag for changes in the value of a particular SP, and bit 1 of the field might be used for setting a “change of quality” (COQ) notification flag for changes in the quality of an SP, etc. While the notification field 178 is depicted in FIG. 6 as having four bits, more or less bits may be designated for this field as necessary for notifying purposes. A date/time field 180 is also included in the SP protocol for conveying the date and the time values of an event that occurs in the control system 110. This field preferably holds a 64-bit floating (i.e., R64) value.

The following predefined message types are sent from the clients 102 to the NPRA 104 and selectively include some of the fields shown in FIG. 5:

| MESSAGE TYPE | MESSAGE ID |
|---|---|
| Discover SP by PUID | MSG_ID_SP_DISCOVER_PUID |
| (unique system point ID) | |
| Discover SP by Name | MSG_ID_SP_DISCOVER_NAME |
| Subscribe Element | MSG_ID_SP_SUBSCRIBE_EL |
| Unsubscribe Element | MSG_ID_SP_UNSUBSCRIBE_EL |
| Unsubscribe All | MSG_ID_SP_UNSUBSCRIBE_ALL_EL |
| Elements | |
| Override/Write SP | MSG_ID_SP_OVERRIDE_WRITE_SP |
| Release | MSG_ID_SP_RELEASE |
| Value/Quality Query | MSG_ID_SP_VAL_QUERY |
| Quality Query | MSG_ID_SP_QUAL_QUERY |
| Node Query | MSG_ID_SP_NODE_QUERY |
| Cancel Transaction | MSG_ID_SP_CANCEL_TRANSACTION |
| Subscribe Event | MSG_ID_SP_SUBSCRIBE_EVENT |
| Unsubscribe Event | MSG_ID_SP_UNSUBSCRIBE_EVENT |
| Subscribe All COS | MSG_ID_SP_SUBSCRIBE_ALL_COS |
| Unsubscribe All COS | MSG_ID_SP_UNSUBSCRIBE_ALL_COS |
| Set Totalized Value | MSG_ID_SP_SET_TOTALIZED_VALUE |
| Resync | MSG_ID_SP_RESYNC |
| Event Report | MSG_ID_SP_EVENT_RPT |

The following predefined message types are sent from the NPRA 104 to the clients 102 and selectively include some of the fields shown in FIG. 5:

| MESSAGE TYPE | MESSAGE ID |
|---|---|
| SP Discovered | MSG_ID_SP_DISCOVERED |
| Value/Quality Report (format 0) | MSG_ID_SP_VAL_RPT_0 |
| Value/Quality Report (format 1) | MSG_ID_SP_VAL_RPT_1 |
| Quality Report (format 0) | MSG_ID_SP_QUAL_RPT_0 |
| Quality Report (format 1) | MSG_ID_SP_QUAL_RPT |
| Event Report | MSG_ID_SP_EVENT_RPT |
| Command NAK | MSG_ID_APPLICATION_ERROR |

It should be noted that each message field is “serialized”, i.e. its bytes are stored in a predefined order. The preferable order is big endian, or the storing the most significant byte (MSB) of the field first.

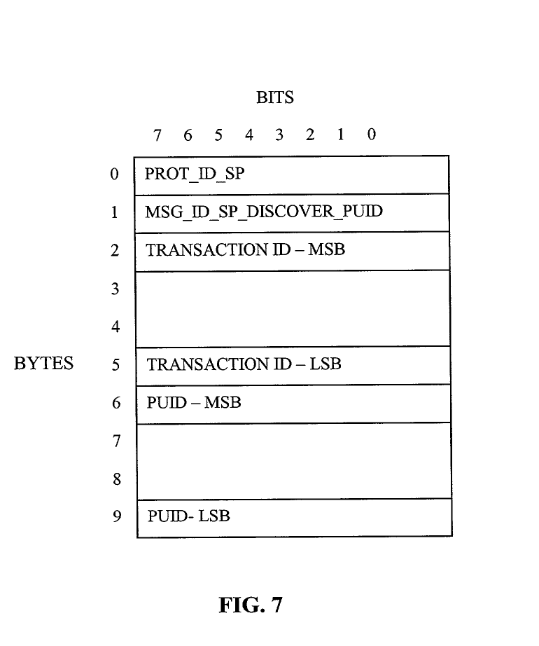

Each SP point in the NPRA 104 is assigned a unique identification (PUID) number. A MSG_ID_SP_DISCOVER_PUID message is broadcast from a client 102 to the NPRA 104 to discover if the NPRA has a specified SP within its database. The PUID number is stored in the PUID field 128 of each SP (best shown in FIG. 4). The NPRA 104 receiving this message responds by sending an “MSG_ID_SP_DISCOVERED” message (discussed below) containing the same TRANSACTION ID (as the MSG_ID_SP_DISCOVER_PUID message) to the client 102, if the SP with the specified PUID number is found in the SP database. The serialized format of the MSG_ID_SP_DISCOVER_PUID message in accordance with the SP protocol is shown in FIG. 7, including the protocol ID field 162, the message field 164, the transaction ID field 168 (shown in FIG. 5). In addition, the MSG_ID_SP_DISCOVER_PUID message also includes a PUID field for identifying the PUID number of the SP stored in the database of the NPRA 104.

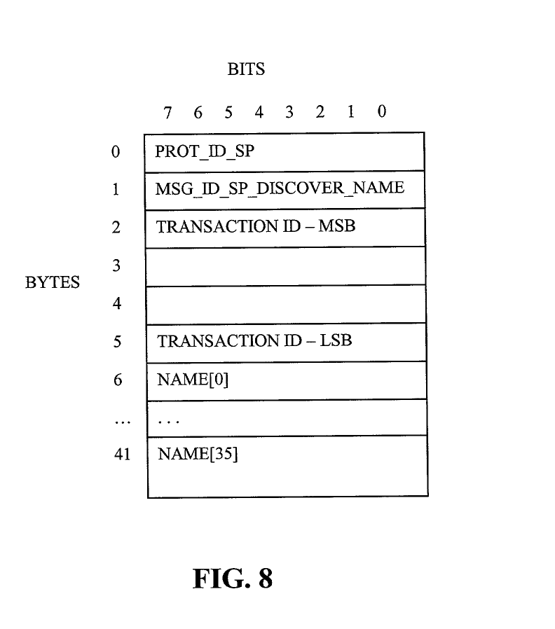

A MSG_ID_SP_DISCOVER_NAME message is sent from the client 102 to the NPRA 104 to discover if a particular SP is stored within its database, as specified by the SP's unique text name. The NPRA 104 responds to this message by sending an “MSG_ID_SP_DISCOVERED” message (discussed below) containing the same TRANSACTION ID (as the MSG_ID_SP_DISCOVER_PUID message) to the client 102, if the SP is found in the SP database that matches the unique text name. The serialized format of the MSG_ID_SP_DISCOVER_NAME message in accordance with the SP protocol is shown in FIG. 8, including the NAME field indicating the text name of the SP.

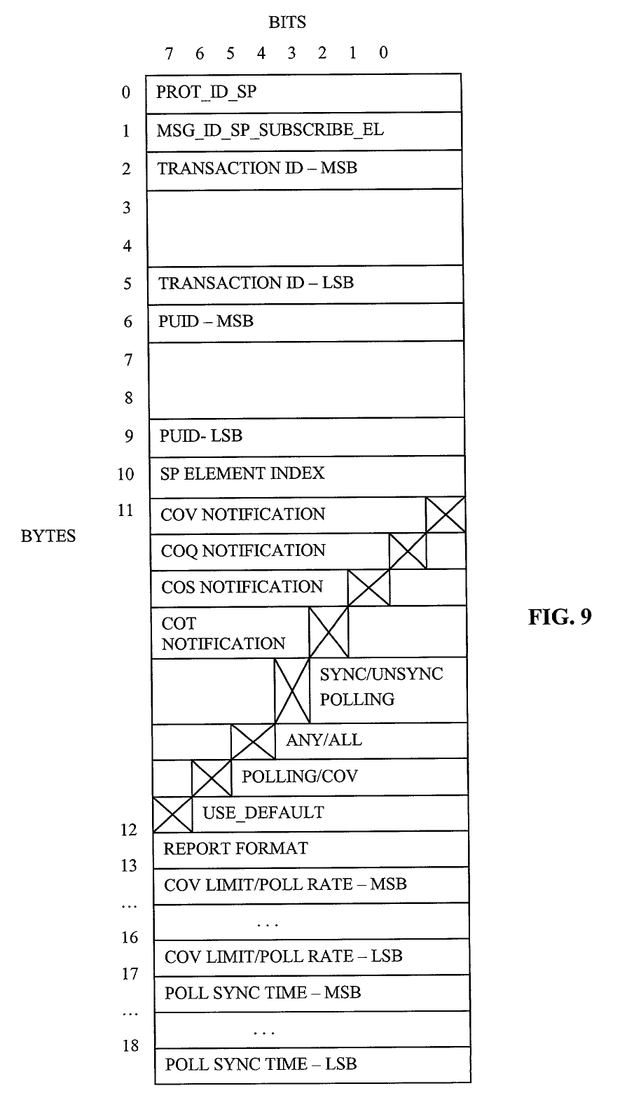

Turning to FIG. 9, a MSG_ID_SP_SUBSCRIBE_EL message is sent from the clients 102 to the NPRA 104 to subscribe for changes in (value, state, quality, etc.) or periodic reporting of a specified element within selected SPs. This message may also be used to subscribe for changes in or periodic reporting of other characteristics of the SPs besides the SP elements.

In addition to the message fields described above in connection with the other SP protocol messages, the MSG_ID_SP_SUBSCRIBE_EL message includes an SP ELEMENT INDEX field that specifies the element within the SP for which the client 102 wishes to subscribe. The SPs include up to 31 elements having values which change independently.

A NOTIFICATION field is provided for setting flags in the bit fields that are used to individually enable specific notifications (for example, change of value (COV), change of quality (COQ), change of state (COS), change of totalization (COT)) that the client is interested in subscribing. A SYNC/UNSYNC POLLING bit in the NOTIFICATION field is reserved for each type of notifications that are set. A “0” in this bit field instructs the NPRA 104 to poll for the specified notifications when the subscription (i.e., the MSG_ID_SP_SUBSCRIBE_EL message) is received, at the specified interval as indicated in a COV LIMIT/POLL RATE field set aside for this purpose. A “1” in this bit instructs the NPRA 104 to poll at the specified interval set in the COV LIMIT/POLL RATE field, but starting only after a predetermined time, i.e., the start of polling is synchronized with a time boundary, as specified in a POLL SYNC TIME field. It should be understood that the POLL SYNC TIME field is only used in the message if the SYNC/UNSYNC POLLING bit is set to “1.” Otherwise, this field is not used in the message.

A “0” (ALL) in an ANY/ALL bit of the NOTIFICATION field indicates that all of the (COV, COQ, COS, COT) notifications enabled by the user in the message must be supported by the SP in the NPRA 104. If the SP does not support any one of the selected notifications, then the message will not be accepted. A “1 ” (ANY) indicates that any of the notifications (COV, COO, COS, COT) enabled by the user and which the SP supports should be applied to the SP at the NPRA 104. The message will be accepted even if the SP does not support all the notifications enabled in the message.

A POLLING/COV bit of the NOTIFICATION field determines whether the enabled notifications should be reported based on polling or when the value of the SP element changes. A USE_DEFAULT bit indicates (if the POLLING/COV bit is set to polling) whether the notification report should be based on the value change limit specified in the COV LIMIT/POLL RATE field of the message or the predefined default limit set in the database of the NPRA 104. It should be noted that the COV LIMIT/POLL RATE field contains either the value change limit or the desired polling rate. A REPORT FORMAT field is used to select a predetermined report format for receiving the reports from the NPRA 104.

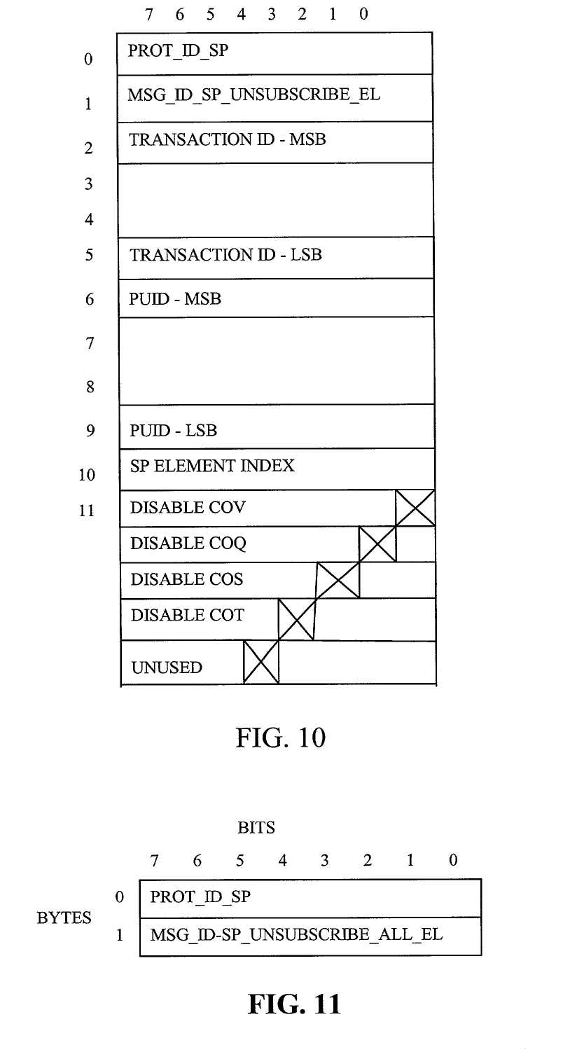

Turning to FIG. 10, a MSG_ID_SP_UNSUBSCRIBE_EL message is sent from the client 102 to the NPRA 104 to cancel the subscription set by the MSG_ID_SUBSCRIBE_EL message. In addition to some of the fields discussed with respect to the MSG_ID_SP_SUBSCRIBE_EL, the MSG_ID_SP_UNSUBSCRIBE_EL message indicates a DISABLE field for specifying the type of notifications (e.g., COV, COO, COS, and/or COT notifications) to unsubscribe.

Turning to FIG. 11, a MSG_ID_SP_UNSUBSCRIBE_ALL_EL message is sent from the client 102 to the NPRA 104 to unsubscribe all notifications (COV, COP, COQ, COS, COT) on all SP elements on all SPs that the client 102 is currently subscribed to. This message is typically be sent at shutdown and start-up by the client 102 (such as the workstation 118) to remove any remaining subscriptions.

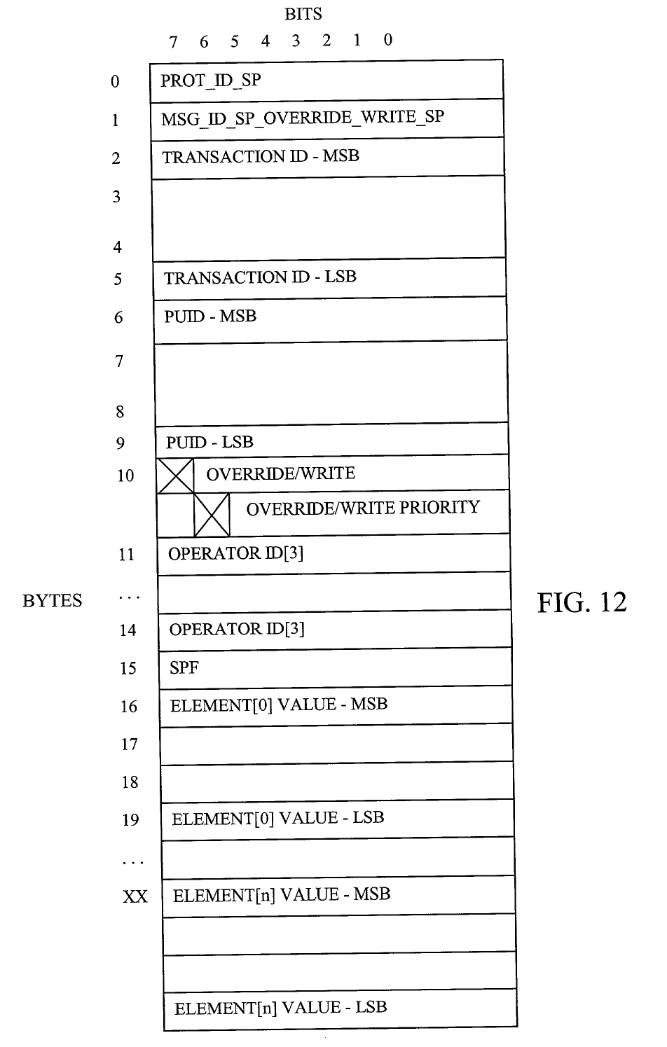

Turning to FIG. 12, a MSG_ID_SP_OVERRIDE_WRITE_SP message is sent from the client 102 to the NPRA 104 to override or write new values to all elements within an SP. In addition to the fields described above in connection with the other SP protocol messages, this message includes a single-byte OVERRIDE/WRITE field including a bit (bit 7) for indicating the type of operation that is desired, i.e., whether override or write, and remaining bits (OVERRIDE/WRITE PRIORITY) indicating the priority of the message. The message will only be accepted by the NPRA 104 if the specified priority is greater than or equal to the current priority for the SP, as indicated in fields 146, 148 of the SP (shown in FIG. 4). If the specified priority is below that of the current priority, a negative acknowledgement (NAK) is returned to the client 102 that sent the message.

In addition to the common fields described above in connection with the other SP protocol messages, the MSG_ID_SP_OVERRIDE_WRITE_SP message includes an OPERATOR ID field which indicates the identity of a user who is responsible for sending the message. An SPF field indicates the total number of elements that are in the SP, and the ELEMENT VALUE fields hold the value of those elements to be overridden or written. In the preferred embodiment, the message only supports numeric element and not string elements. Element values are conveyed as a 32-bit floating point number (i.e. an R32 number), and accordingly require 4 bytes for each value, which are arranged from the most significant byte (MSB) to the least significant byte (LSB), as shown in FIG. 12.

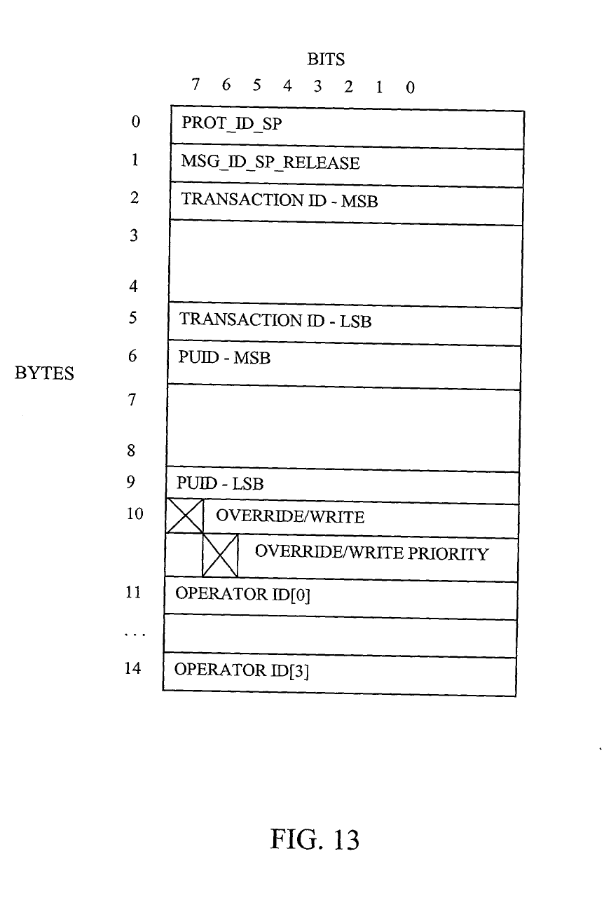

Turning to FIG. 13, a MSG_ID_SP_RELEASE message is sent from the client 102 to the NPRA 104 to release an SP from an override or write restriction so that other lower priority clients 102 are allowed to override or write to the SP. The effect of the release is to clear the priority of the SP. It should be noted that any client 102 can send this message, and not just the one that set the override or write of the SP. However, the message will only be accepted if the priority of the client 102 is greater than or equal to the current priority for the SP. Otherwise, a NAK is returned to the client 102. In addition to the common fields described above in connection with the other messages, this message includes a single byte OVERRIDE/WRITE field including a bit (bit 7) for identifying the type of release, i.e., whether the release is for an override or a write. The remaining bits of of this field (OVERRIDE/WRITE PRIORITY) indicates the priority of the message so that the NPRA 104 is able to determine whether the message can be accepted.

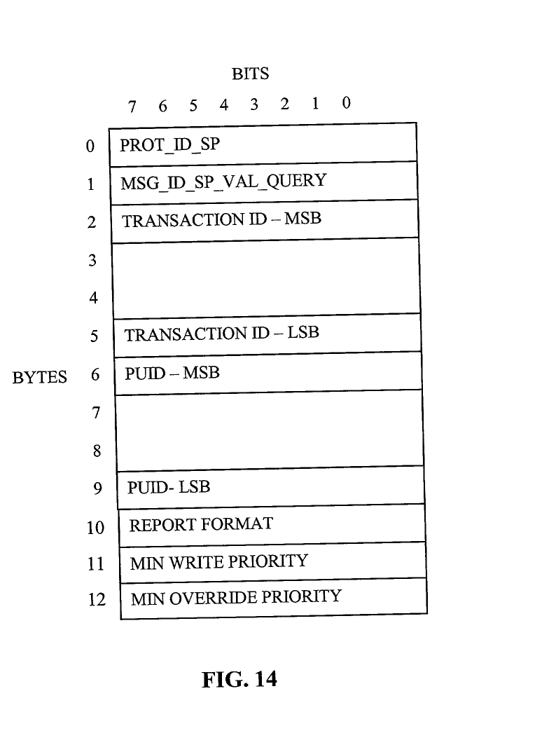

A MSG_ID_SP_XX_QUERY message is sent from the client 102 to the NPRA 104 to request a report on one or more SPs that currently have a particular data which is of interest to the client 102 sending the message. For example, a MSG_ID_SP_VAL_QUERY message, as depicted in in FIG. 14, is sent to request a report on an SP or on all the SPs that current have a write priority that is greater than or equal to the specified minimum write priority, and an override priority that is greater than or equal to the specified minimum override priority. Accordingly, in addition to the common fields described above, the MSG_ID_SP_VAL_QUERY message includes MIN WRITE PRIORITY and MIN OVERRIDE PRIORITY fields.

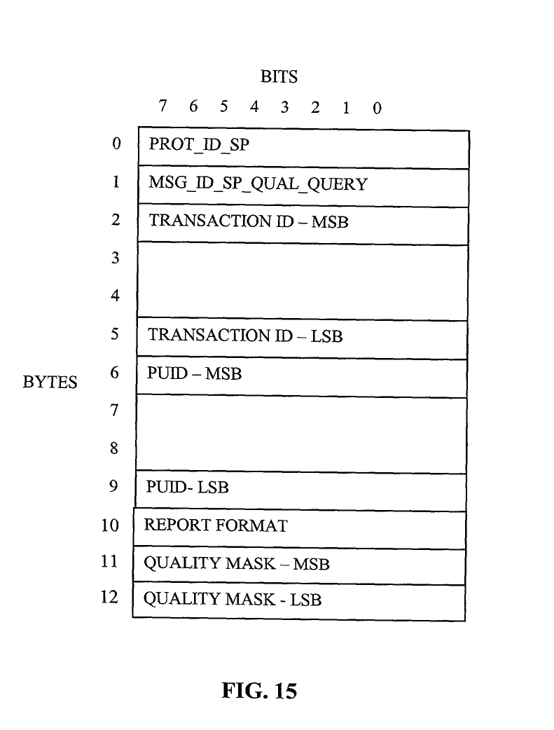

Turning to FIG. 15, a MSG_ID_SP_QUAL_QUERY message is sent from the client 102 to the NPRA 104 to request a report on one or more SPs that conform to the specified quality mask, which indicates whether the source of the data is operational. An example of an SP having a bad quality would be an SP that corresponds to a system variable (SV) which originated from a network device 114 or the device controllers 112, 116 (shown in FIG. 2) that has experienced a failure.

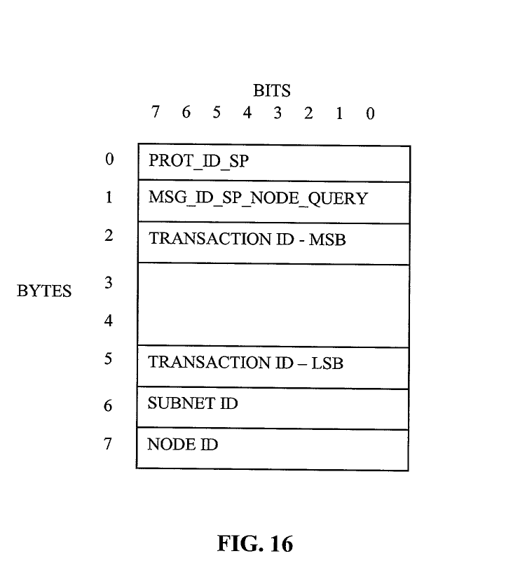

Turning to FIG. 16, a MSG_ID_SP_NODE_QUERY message is sent from the client 102 to the NPRA 104 to instruct the NPRA to immediately schedule a node for interrogation to determine if that node has failed or is operational, rather than waiting for the scheduled next scan by the NPRA. In addition to the common fields described above in connection with the other messages, the MSG_ID_SP_NODE_QUERY message includes a SUBNET ID field and a NODE ID field which identify the logical network address of the node being queried.

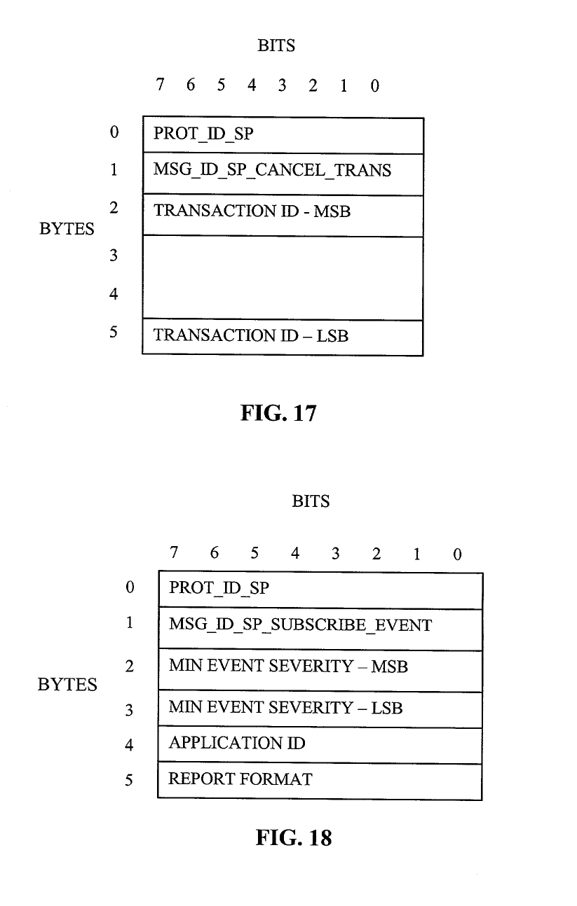

Turning to FIG. 17, the MSG_ID_SP_CANCEL_TRANSCTION message is sent from the client 102 to the NPRA 104 to cancel a previously sent MSG_ID_SP_XX_QUERY message. The transaction to be cancelled is specified by the TRANSACTION ID field.

Turning to FIG. 18, the MSG_ID_SP_SUBSCRIBE_EVENT message is sent from the client 102 to the NPRA 104 to subscribe for event notifications. The term “event” is defined to mean general error conditions in the applications (clients) 102 in the control system 110. The message includes a MINIMUN EVENT SEVERTITY field that instructs the NPRA 104 to only report events that have a predefined severity level that is higher than the level indicated in this field. An APPLICATION ID field identifies the applications (clients) 102 for which the event notification is desired.

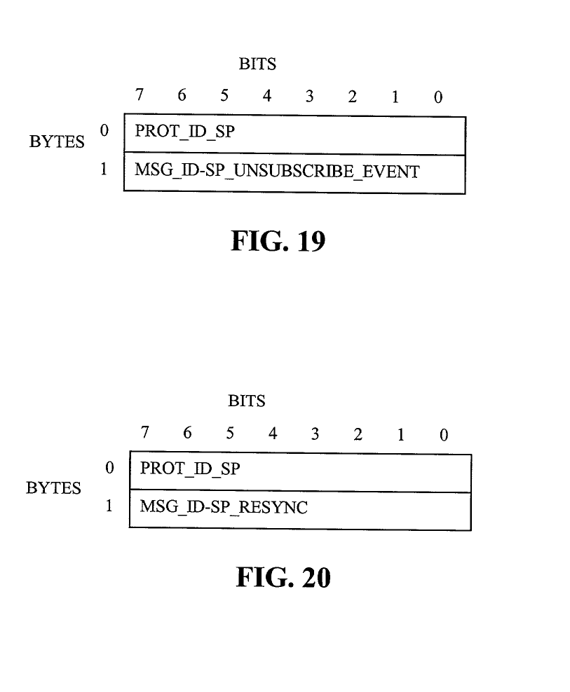

A MSG_ID_SP_UNSUBSCRIBE_EVENT message is sent from the client 102 to the NPRA 104 to unsubscribe for the event notifications described above. The SP protocol for this message is shown in FIG. 19.

Turning to FIG. 20, a MSG_ID_SP_RESYNC message is sent from the client 102 to the NPRA 104 to instruct the NPRA to resynchronize or query all of the SV servers 106 operatively connected to the NPRA to determine which SVs are currently overridden, and then update the NPRA database with the results of these queries.

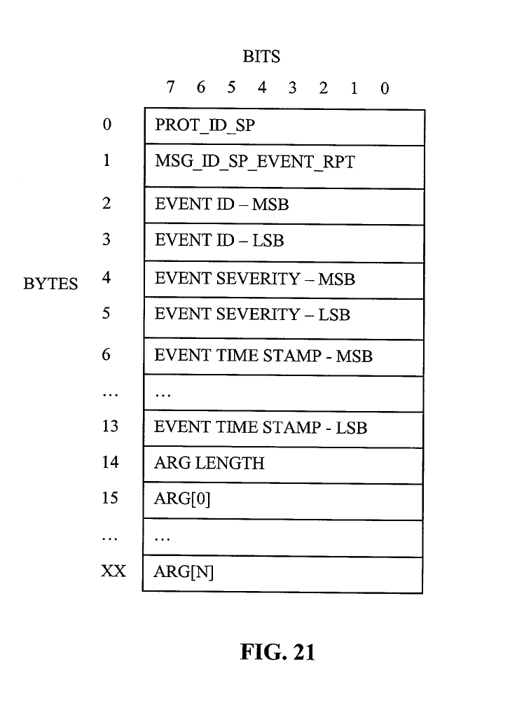

Turning to FIG. 21, a MSG_ID_SP_EVENT_RPT message is sent from the client 102 (or the NPRA 104 itself) to the NPRA 104 to report the occurrence of an event detected by the client, such as a node failure event or node return-from failure event detected by a NPRA. In addition to the common fields described above, the MSG_ID_SP_EVENT_RPT message includes an EVENT ID field indicating the type of predefined event that has occurred. The events have a predefined severity level, and those events that have severity level above the minimum level indicated in the EVENT SEVERITY field are reported to the NPRA 104. An EVENT TIME STAMP field is provided in the message to record the time of the event. The MSG_ID_SP_EVENT_RPT message further includes an ARG LENGTH field that indicates the number of bytes that are in an ARGUMENT field, which provides the detailed information about the event that is being reported.

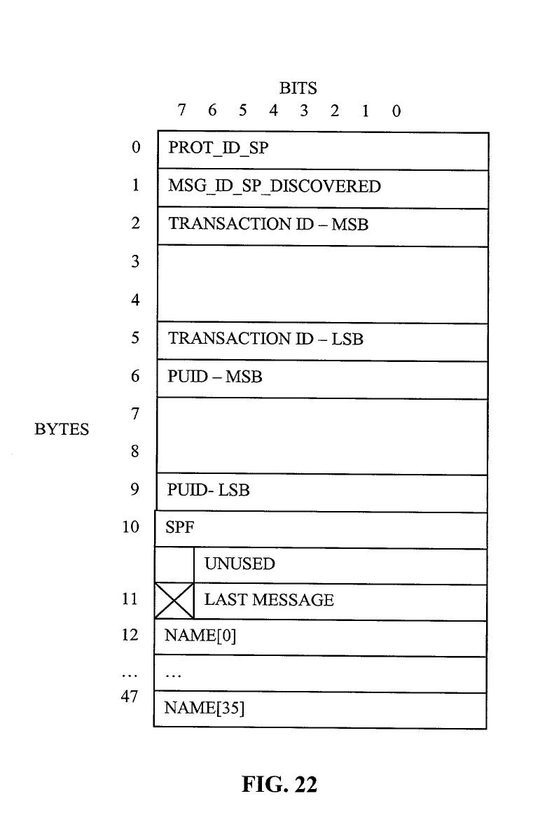

Turning to FIG. 22, a MSG_ID_SP_DISCOVERED message is sent from the NPRA 104 to a client 102 in response to a command from the client to discover SP by its point unique ID (PUID) number or its name (MSG_ID_SP_DISCOVER_PUID and MSG_ID_SP_DISCOVER_NAME messages shown in FIGS. 7 and 8) discussed above, if the specified SP was found within the database of the NPRA. This message includes, in addition to the common fields described above, a LAST MESSAGE field for indicating whether this message is the last message associated with the transaction identified in the TRANSACTION ID field.

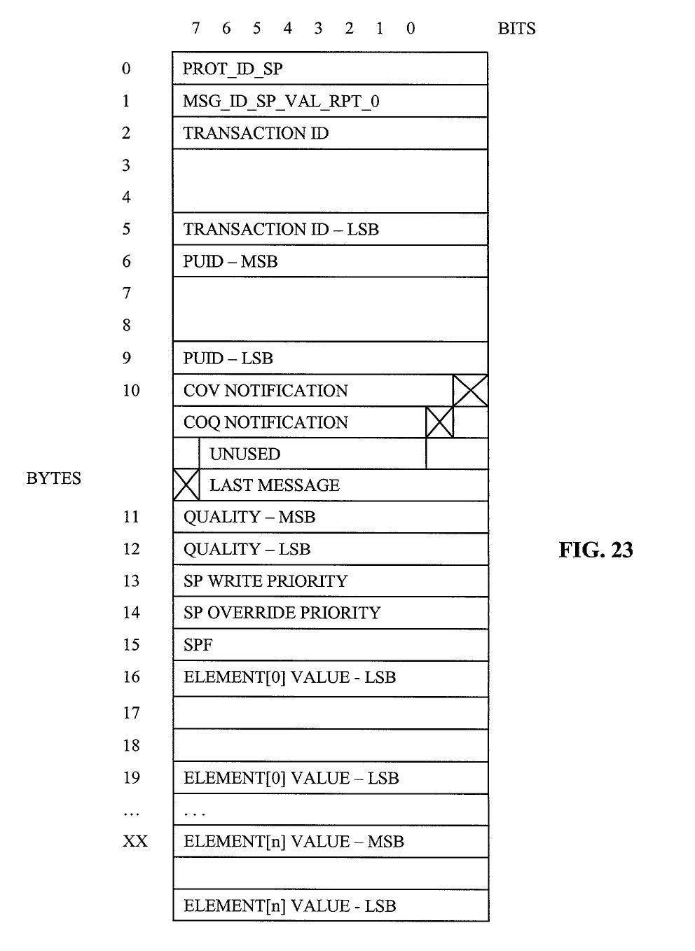

Turning to FIG. 23, a MSG_ID_SP_VAL_RPT message is sent from the NPRA 104 to the clients 102 in response to requests from the clients for reports on the SPs for data of interest. In the preferred embodiment, this message is used to report the occurrence of a change of value (COV) and/or change of quality (COQ) for the specified SP and of a change of priority (COP) of the write priority and/or override priority for the specified SP. This message is used also in response to the MSG_ID_SP_SUBSCRIBE_EL message (shown in FIG. 9), for subscribing for an element of the SP, and in response to a request for a report on an SP that has a write priority that is greater than or equal to a specified minimum write priority and an override priority that is greater than or equal to the specified minimum override priority, i.e., the MSG_ID_SP_VAL_QUERY message (shown in FIG. 14) discussed above.

As seen in FIG. 23, the MSG_ID_SP_VAL_RPT message includes, in addition to the common fields discussed above in connection with the other messages, a NOTIFICATION field that has bit flags to indicate a change of value (COV) and a change of quality (COQ), if this message is sent as a COV/COQ notification report. If this message is sent in response to a query messages (the MSG_ID_SP_XX_QUERY messages shown in FIGS. 14-16), then the flags are cleared. A QUALITY field indicates the current quality level of the data source, which is needed if this report is in response to a query regarding quality, i.e., the MSG_ID_SP_QUAL_QUERY message (shown in FIG. 15). SP WRITE PRIORITY and the SP OVERRIDE PRIORITY fields convey the current write and override priority of the SP. The SPF field indicates the number of SP elements that are in the specified SP.

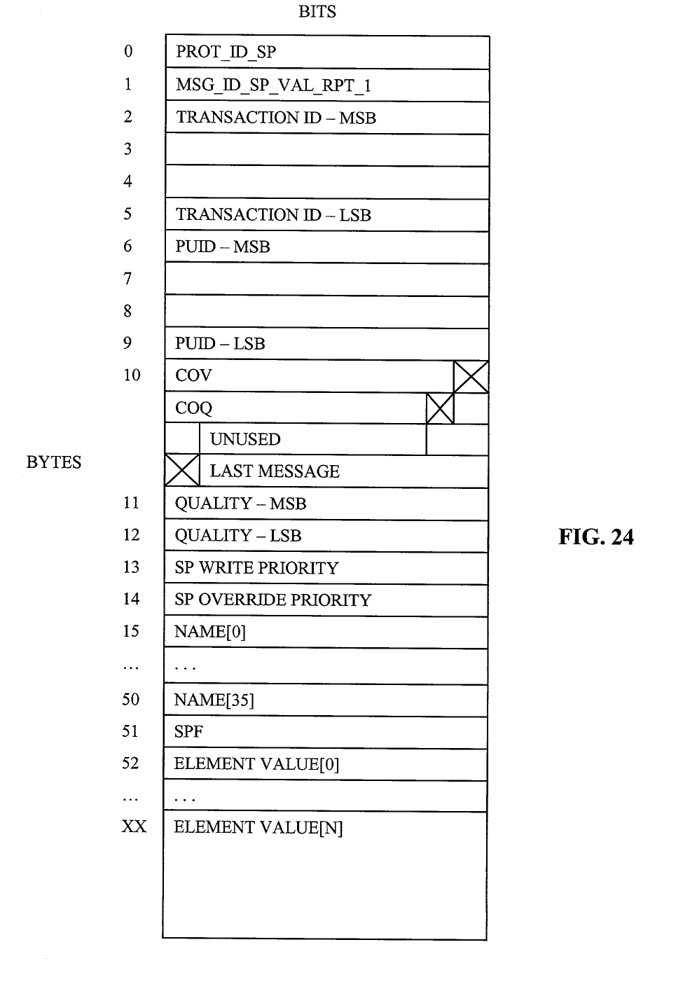

It should be noted that the report format of the MSG_ID_SP_VAL_RPT may be modified to provide the information specified by the requesting client 102. An example of an alternate format for reporting the MSG_ID_SP_VAL_RPT message is shown in FIG. 24, which in addition to the fields shown in FIG. 23, further includes a NAME field for providing the name of the specified SP, if this information is requested by the client 102.

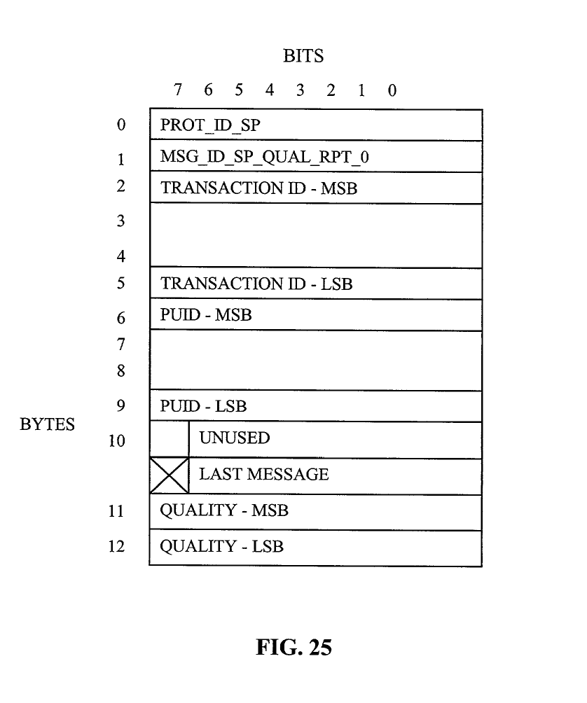

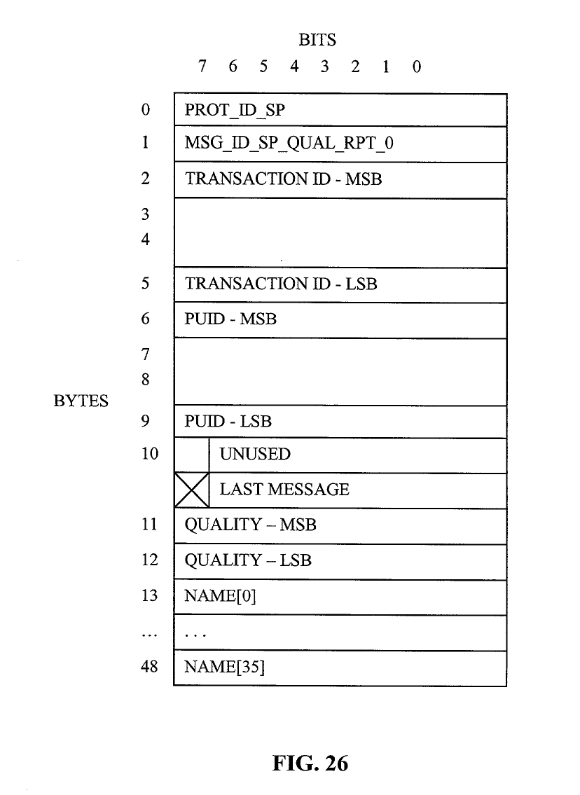

Turning to FIG. 25, a MSG_ID_SP_QUAL_RPT message is sent from the NPRA 104 to the client 102 in response to the MSG_ID_SP_QUAL_QUERY message (shown in FIG. 15) or the MSG_ID_SP_SUBSCRIBE_EL message (shown in FIG. 9) with the COQ notification bit specified. In addition to the common fields described above in connection with the other messages, a QUALITY field indicates the predefined level of quality associated with the specified SP. The report format may be modified to provide the information specified by the requesting client 102. An example of an alternate format for reporting the MSG_ID_SP_QUAL_RPT message is shown in FIG. 26, which in addition to the fields shown in FIG. 25, further includes a NAME field for providing the name of the specified SP, if this information is requested by the client 102.

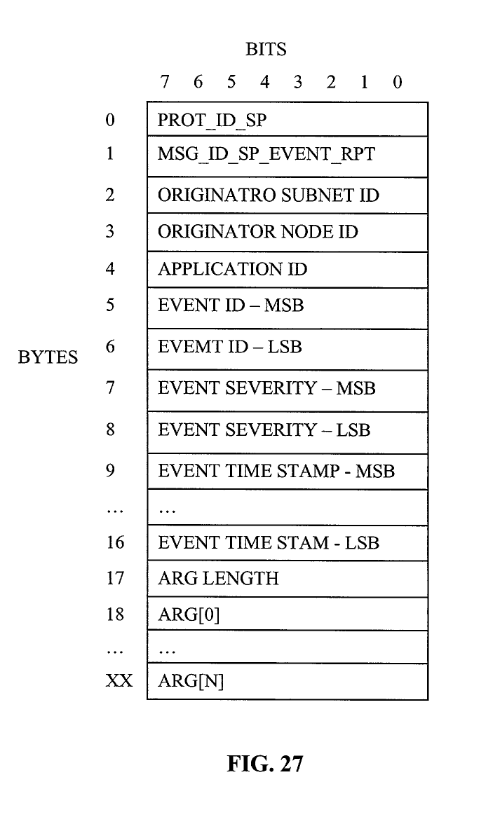

Turning to FIG. 27, a MSG_ID_SP_EVENT_RPT message is sent from the NPRA 104 to the client 102 to report the occurrence of the events specified by the client. In addition to the common fields described above in connection with the other messages, this message further includes ORIGINATOR SUBNET ID and ORIGINATOR NODE ID fields for identifying the logical network address of the node of the application (i.e., the client) 102 that has experienced the subscribed event. An APPLICATION ID FIELD identifies the application 102 that has detected the event. An EVENT ID field identifies the type of event that has occurred at the application 102, and an EVENT SEVERITY field indicates the level of severity of the event, which is predetermined for each event. An EVENT TIME STAMP shows the time at which the event has occurred, and an ARG LENGTH field indicates the number of bytes (in the ARG field) that are used to provide detailed information (argument) regarding the event.

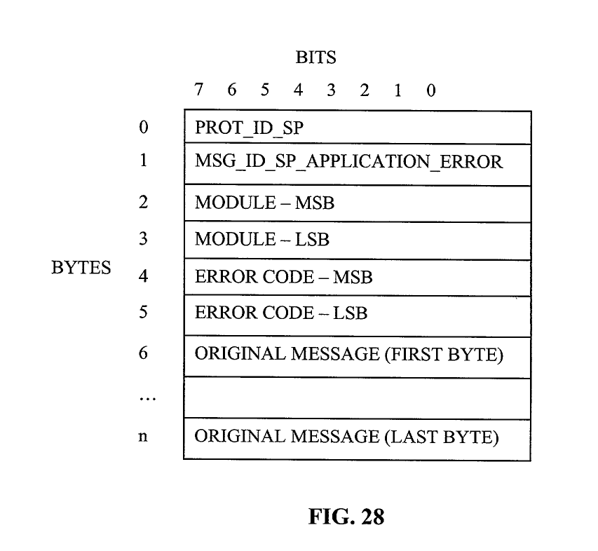

Turning to FIG. 28, a MSG_ID_APPLICATION_ERROR message is sent from the NPRA 104 to the client 102 report that the NPRA was unable to execute the specified command from the client. A MODULE field indicates the software module where the error occurred, while an ERROR code field indicates the type of error that occurred (i.e., the reason why the NPRA 104 could not execute the command message). An ORIGINAL MESSAGE field contains the original command message that the NPRA 104 was unable to execute.

From the foregoing description, it should be understood that an improved protocol for a control network has been shown and described which has many desirable attributes and advantages. The SP protocol is advantageously employed in a system controller which is adapted to be integrated with any standard network control network. The present protocol serves to transmit data relating to “system points,” which convey information regarding desired system or user-defined variables in the network. The present protocol is used to transmit system point data between the network point record application (NPRA) and the various applications in the network.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims. Various features of the invention are set forth in the appended claims

What is claimed is:

1. A proprietary communication protocol for use in a system controller that includes an application controller and a plurality of applications for controlling a plurality of device controllers on a control network by using data relating to system points that correspond to data variables in the network, said proprietary communication protocol comprising:
a plurality of predefined messages transmitted between the application controller and the applications for instructing the application controller to perform a function relating to a select system point, and for reporting to the applications in response to said instruction;
a message identification field for identifying a select message from said plurality of messages; and,
a protocol identification field for identifying said select message as being transmitted via said proprietary communication protocol.

2. The proprietary communication protocol as defined in claim 1 wherein said proprietary communication protocol is embedded into a communication protocol of the control network.

3. The proprietary communication protocol as defined in claim 1 further including a system point identification field for identifying the select system point.

4. The proprietary communication protocol as defined in claim 3 wherein said system point identification field is a point unique identification (PUID) field for identifying the select system point by a unique identification number that is assigned to the select system point.

5. The proprietary communication protocol as defined in claim 3 wherein said system point identification field is a name identification field for identifying the select system point by a user-defined name that is assigned to the select system point.

6. The proprietary communication protocol as defined in claim 1 further including a priority field for determining whether data relating to the select system point can be written to.

7. The proprietary communication protocol as defined in claim 1 further including a priority field for determining whether data relating to the select system point can be overridden.

8. The proprietary communication protocol as defined in claim 1 further including a transaction identification field for uniquely identifying said select message from the plurality of predefined messages.

9. The proprietary communication protocol as defined in claim 1 further including a field for indicating whether said select message is a last message being transmitted from the application controller to the applications.

10. The proprietary communication protocol as defined in claim 1 further including a field for indicating at least one element value of the select system point.

11. The proprietary communication protocol as defined in claim 10 further including a field for determining a format for displaying said element values.

12. The proprietary communication protocol as defined in claim 1 further including a notification field for indicating at least one type of changes in the data relating to the select system point for which at least one of the applications desires subscription.

13. The proprietary communication protocol as defined in claim 12 wherein said changes include a change of value, a change of state and a change of quality relating to the select system point.

14. The proprietary communication protocol as defined in claim 1 wherein said plurality of messages include a discover message transmitted from the applications to the application controller for inquiring whether the select system point is stored in a database of the application controller.

15. The proprietary communication protocol as defined in claim 14 wherein said discover message refers to the select system point via a unique identification number associated with the system point.

16. The proprietary communication protocol as defined in claim 14 wherein said discover message refers to the select system point via a user-defined name that is assigned to the select system point.

17. The proprietary communication protocol as defined in claim 14 wherein said plurality of messages include a message transmitted from the application controller to the application in response to said discover message to report that the select system point is stored in said database.

18. The proprietary communication protocol as defined in claim 1 wherein said plurality of messages include a message transmitted from the applications to the application controller for subscribing for changes in the data relating to the select system point.

19. The proprietary communication protocol as defined in claim 18 wherein said changes include a change of value, a change of state and a change of quality relating to the select system point.

20. The proprietary communication protocol as defined in claim 18 wherein said plurality of messages includes a message transmitted from the applications to the application controller for unsubscribing for changes in the data relating to the select system point

21. The proprietary communication protocol as defined in claim 18 wherein said plurality of messages include a message transmitted from the application controller to the applications reporting of said changes in the data relating to the select system point in response to said subscription message transmitted from the applications.

22. The proprietary communication protocol as defined in claim 1 wherein said plurality of messages includes a message transmitted from the applications to the application controller for overriding or writing new values in the data relating to the select system point.

23. The proprietary communication protocol as defined in claim 22 wherein said overriding and writing message is accepted by the application controller if a priority of an application transmitting said message is greater than or equal to a priority of the data relating to the select system point.

24. The proprietary communication protocol as defined in claim 23 wherein said plurality of messages includes a message transmitted from the applications to the application controller for releasing said priority of the data relating to the selected system point to allow an application having a lower priority than said priority of the data to override or write new value in the data relating to the select system point.

25. The proprietary communication protocol as defined in claim 1 wherein said plurality of messages includes a message transmitted from the applications to the application controller for requesting query of the data relating to at least one of the system points for specified information.

26. The proprietary communication protocol as defined in claim 25 wherein said query message requests a report on all system points that have a write or override priority that is greater than or equal to a specified priority level of said query message.

27. The proprietary communication protocol as defined in claim 25 wherein said query message requests a report on all system points that conforms to a specified quality.

28. The proprietary communication protocol as defined in claim 25 wherein said query message requests a report on all system points that a status of at least one node of the control network.

29. The proprietary communication protocol as defined in claim 1 wherein said plurality of messages includes a message transmitted from the applications to the application controller for canceling a previously transmitted message.

30. The proprietary communication protocol as defined in claim 1 wherein said plurality of messages includes a message transmitted from the applications to the application controller for canceling a previously transmitted message.

31. The proprietary communication protocol as defined in claim 1 wherein said plurality of messages includes a message transmitted from the applications to the application controller for instructing the application controller to query all of the data variables in the network operatively connected to the application controller to determine if any of the data variables have been overridden.

32. The proprietary communication protocol as defined in claim 1 wherein each of the system points are identified by a unique numeric value.

33. The proprietary communication protocol as defined in claim 1 wherein the system points are identified by a user-defined name.

34. The proprietary communication protocol as defined in claim 1 wherein each of the system points include at least one element value.

35. The proprietary communication protocol as defined in claim 1 wherein the system points have an assigned write priority and an override priority.

36. The proprietary communication protocol as defined in claim 1 wherein the data relating to the system points are stored in a database of the application controller.

37. The proprietary communication protocol as defined in claim 36 wherein said database stores user-defined data relating to the system points.

38. The proprietary communication protocol as defined in claim 37 wherein said database stores a unique identification value of the corresponding data variables in the network.

39. The proprietary communication protocol as defined in claim 37 wherein said database includes field for storing an address of the corresponding data variables in the network.

40. A proprietary communication protocol for use in a system controller that includes an application controller and a plurality of applications for controlling a plurality of device controllers on a control network by using data relating to system points that correspond to data variables in the network, said proprietary communication protocol comprising:
a plurality of predefined messages transmitted between the application controller and the applications for instructing the application controller to report an event that occurs in the applications and the device controllers, and for reporting to the applications in response to said instruction;
a message identification field for identifying a select message from said plurality of messages; and,
a protocol identification field for identifying said select message as being transmitted via said proprietary communication protocol.

41. The proprietary communication protocol as defined in claim 40 further including an event identification field identifying said event.

42. The proprietary communication protocol as defined in claim 40 further including a field for indicating a time and a date in which said event has occurred.

43. The proprietary communication protocol as defined in claim 40 wherein said plurality of messages include a message for subscribing for a failure in the applications.

44. The proprietary communication protocol as defined in claim 43 wherein said plurality of messages include a message for canceling said subscription for said failure in the applications.

45. The proprietary communication protocol as defined in claim 43 wherein said plurality of messages include a message for reporting of said failure in one of the applications to the application controller.

46. The proprietary communication protocol as defined in claim 45 wherein said plurality of messages include a message for reporting of said failure reported by the one of the applications to the other of the applications.
